(19) United States
(12) Patent Application Publication
(10) Pub. No.: US 2016/0177123 A1
(43) Pub. Date: Jun. 23, 2016

(54) THERMALLY POST-CURING SYSTEMS THAT CROSSLINK WITH ACTINIC RADIATION

(71) Applicants: Emmanouil SPYROU, Schermbeck (DE); Zuhal Tuncay, Herne (DE); Andrea Diesveld, Gescher (DE); Marion Ewald, Marl (DE); Holger Loesch, Herne (DE)

(72) Inventors: Emmanouil SPYROU, Schermbeck (DE); Zuhal Tuncay, Herne (DE); Andrea Diesveld, Gescher (DE); Marion Ewald, Marl (DE); Holger Loesch, Herne (DE)

(73) Assignee: Evonik Degussa GmbH, Essen (DE)

(21) Appl. No.: 14/958,962

(22) Filed: Dec. 4, 2015

(30) Foreign Application Priority Data
Dec. 19, 2014 (EP) 14199251

(51) Int. Cl. C09D 133/08; B05D 3/06

(52) U.S. Cl. CPC C09D 133/08; B05D 3/06

(57) ABSTRACT

A thermally curable and radiation-curable formulation, contains A) 45% to 99.9% by weight of at least one radiation-curable component; and B) 0.1% to 5% by weight of at least one selected free-radically initiating photo-initiator; and optionally C) 0.01% to 50% by weight of at least one additive; wherein the sum total of A) and B) and any C) is 100% by weight. The formulation is curable with actinic radiation and/or thermally and is used, for example, for the production of pigmented and pigment-free coating materials, and for adhesives and sealants.

### BACKGROUND OF THE INVENTION

1. Field of the Invention

The present invention relates to novel formulations curable with actinic radiation and by thermal means. The present invention also relates to the use of the novel formulations curable with actinic radiation and by thermal means for the production of pigmented and pigment-free coating materials, and for adhesives and sealants.

2. Discussion of the Background

Formulations curable with actinic radiation are known.

Ethylenically unsaturated prepolymers are described, for example, in P. K. T. Oldring (ed.), “Chemistry and Technology of UV- and EB-Formulations for Coatings, Inks and Paints”, Vol. II. SITA Technology, London 1991, for example on the basis of epoxy acrylates (pages 31 to 68), urethane acrylates (pages 73 to 123) and melamine acrylates (pages 208 to 214). In the patent literature too, formulations of this kind are frequently mentioned, for example in JP 62110779 and EP 947 565.

Disadvantages of such radiation-curable formulations are usually low flexibility, but also the restriction that flat substrates are the primary option for coating. It is true that there has been no lack of attempts in the last few years to coat three-dimensional substrates as well in this way, for example by means of mechanical apparatuses which either rotate the substrate or else move the lamps, by means of an elaborate mirror technique or by means of plasma chambers. However, the not inconsiderable additional complexity has caused such applications to be restricted very substantially to niches.

The coating of metallic substrates is a particular problem for radiation-curable formulations, since there can be a loss of adhesion because of shrinkage processes. Therefore, phosphoric acid-containing adhesion promoters are frequently used for such substrates. Examples of these are U.S. Pat. No. 5,128,387 (coating of beer cans) and JP 2001172554 (coating of various cans).

As is well known, epoxy acrylates exhibit excellent adhesion and good corrosion protection on metal substrates. However, a disadvantage of such coatings is low deformability after curing. For some coating technologies, for example coil coating, the deformability of the coated workpieces without formation of cracks in the coating is crucial. Moreover, coatings of this kind have a tendency to yellow because of their aromatic components.

WO 03/022945 describes low-viscosity radiation-curable formulations for metal substrates based on radiation-curable resins, monofunctional reactive diluents and acidic adhesion promoters. The resins used are standard commercial products available from various suppliers.

EP 902 040 also relates to radiation-curable formulations. Described therein are urethane (meth)acrylates with monofunctional esters of unsaturated carboxylic acid, which are esterified with alcohols containing a carbocycle or a heterocycle.

However, the systems known from the related art exhibit disadvantages in many cases; more particularly, the curing of three-dimensional substrates in the shadow zone can be accomplished with difficulty, if at all.

Therefore, dual-cure systems have been promoted for some time, which include other curing methods as well as curing by radiation, for example WO2001/46286, WO200146285, WO2001/42329, WO2001/23453, WO2000/39183, EP1138710, EP1103572, EP1085065, EP928800. These describe the reaction of isocyanate-functionalized binder constituents with hydroxy-functionalized components, which leads to additional crosslinking.

If free isocyanates are used here, as, for example, in WO2001/46286, this results in a two-pack formulation with limited pot life.

If, in contrast, externally blocked isocyanurates (e.g. WO2001/23453) are used, blocking agents are released into the environment during the curing reaction, and this is undesirable for environmental reasons.

The use of internally blocked isocyanurates (uretdiones) in dual-cure systems is described in WO 03/016376. The use of uretdione-containing components in this case leads to improved intermediate adhesion, but in the examples adduced has no effect on the hardness and scratch resistance of the coating (Examples 3, 4 and V2). No example shows the performance of the coating with thermal curing alone, without radiative curing (i.e. a simulation of the shadow regions). Moreover, isocyanates are comparatively costly.

Thermal post-curing of radiation-curable formulations has long been known, particularly for cationically initiated systems. In the case of free-radically photopolymerized formulations, this is less common and is generally restricted to sterically hindered free radicals (see “Dark Reactions of Free Radicals Trapped in Densely Crosslinked Polymer Networks After Photopolymerization” in Journal of Applied Polymer Science, Vol. 89, 579-588 (2003) © 2003 Wiley Periodicals, Inc.).

### SUMMARY OF THE INVENTION

The problem addressed by the present invention was that of developing formulations curable with actinic radiation and by thermal means, which, after thermal curing and prior radiative curing, give rise to a bond or a seal that meets minimum demands, i.e. is tack-free, flexible and chemical-resistant. Moreover, this formulation, for environmental reasons, is to be free of blocking agents and is to be curable below 160° C., in order also to be an option for thermally sensitive substrates. More particularly, it should be possible to partly cure a coating with radiation, then to process the substrate further, for example by shaping, bonding or overcoating, and then to fully cure the coating.

The present invention provides a process for producing a coating, comprising:
applying a thermally curable and radiation-curable formulation to a substrate, to obtain a coated substrate;
curing said thermally curable and radiation-curable formulation at least partly but not fully with radiation, to obtain a partly cured coated substrate; wherein an average of at least 20% to not more than 95% of polymerizable double bonds of the thermally curable and radiation-curable formulation are reacted during the curing;
   wherein the thermally curable and radiation-curable formulation comprises
      A) 45% to 99.9% by weight of at least one radiation-curable component; and
      B) 0.1% to 5% by weight of at least one selected free-radically initiating photo-initiator;
      and optionally
      C) 0.01% to 50% by weight of at least one additive;
      wherein the sum total of A) and B) and any C) is 100% by weight;
and then thermally heating the coating on the substrate at a temperature from 60 to 220° C., to fully cure the coating, to obtain a cured coating.

The present invention further provides that the photo-initiator B) is selected according to the following method in a preliminary test:
2% by weight of the photo-initiator is dissolved in isobornyl acrylate and coated with a layer thickness of 100 μm on a substrate and 20-80% of the double bonds of the isobornyl acrylate are free-radically polymerized by a UV lamp, to obtain a coating having a maximum in the exothermic peak in degrees Celsius at temperatures less than or equal to 160° C., as measured by DSC according to DIN EN ISO 11357-1.

In another embodiment, the present invention provides a thermally curable and radiation-curable formulation, comprising:
A) 45% to 99.9% by weight of at least one radiation-curable component; and
B) 0.1% to 5% by weight of at least one selected free-radically initiating photo-initiator;
and optionally
C) 0.01% to 50% by weight of at least one additive;
wherein the sum total of A) and B) and any C) is 100% by weight.

In the above thermally curable and radiation-curable formulation, the photo-initiator B) is selected according to the following test:
2% by weight of the photo-initiator is dissolved in isobornyl acrylate and coated with a layer thickness of 100 μm on a substrate and 20-80% of the double bonds of the isobornyl acrylate are free-radically polymerized by a UV lamp, to obtain a coating having a maximum in the exothermic peak in degrees Celsius at temperatures less than or equal to 160° C., as measured by DSC according to DIN EN ISO 11357-1.

In yet another embodiment, the present invention provides for a coating material, intermediate layer, topcoat, clearcoat, adhesive or sealant material, comprising:
the above thermally curable and radiation-curable formulation.

### DETAILED DESCRIPTION OF THE INVENTION

It has been found that, surprisingly, a process according to the invention overcomes the above mentioned problems.

Any ranges mentioned below include all values and subvalues between the lowest and highest limit of the respective range.

The present invention provides a process for producing coatings by curing thermally curable and radiation-curable formulations composed of
A) 45% to 99.9% by weight of at least one radiation-curable component and
B) 0.1% to 5% by weight of at least one selected free-radically initiating photo-initiator;
and optionally
C) 0.01% to 50% by weight of at least one additive,
and the sum total of A) and B) and any C) is 100% by weight,
wherein said formulation, after application to a substrate, is cured at least partly with radiation, wherein an average of at least 20% to not more than 95% of the polymerizable double bonds are reacted, then the coated substrate is processed further, and then the coating on the substrate is heated thermally at from 60 to 220° C., and the coating is cured fully.

The present invention provides, in a second aspect, a process for producing coatings by
I) selecting the selected photo-initiator B) according to the following method and with the following condition:
   2% by weight of the photo-initiator is dissolved in isobornyl acrylate and 20-80% of the double bonds are free-radically polymerized on a substrate by means of a UV lamp with a layer thickness of 100 μm, to obtain a coating having a maximum in the exothermic peak in degrees Celsius at temperatures less than or equal to 160° C., measured by means of DSC to DIN EN ISO 11357-1;
II) curing thermally curable and radiation-curable formulations composed of
   A) 45% to 99.9% by weight of at least one radiation-curable component and
   B) 0.1% to 5% by weight of at least one selected free-radically initiating photo-initiator;
   and optionally
   C) 0.01% to 50% by weight of at least one additive,
   and the sum total of A) and B) and any C) is 100% by weight,
wherein said formulation, after application to a substrate, is cured at least partly with radiation, wherein an average of at least 20% to not more than 95% of the polymerizable double bonds are reacted, then the coated substrate is processed further, and then the coating on the substrate is heated thermally at from 60 to 220° C., and the coating is cured fully.

The present invention also provides thermally curable and radiation-curable formulations composed of
A) 45% to 99.9% by weight of at least one radiation-curable component and
B) 0.1% to 5% by weight of at least one selected free-radically initiating photo-initiator;
and optionally
C) 0.01% to 50% by weight of at least one additive, and the sum total of A) and B) and any C) is 100% by weight.

The photo-initiator selected meets the following condition:
2% by weight of the photo-initiator is dissolved in isobomyl acrylate and 20-80% of the double bonds are free-radically polymerized on a substrate by means of a UV lamp with a layer thickness of 100 μm, to obtain a coating having a maximum in the exothermic peak in degrees Celsius at temperatures less than or equal to 160° C., measured by means of DSC to DIN EN ISO 11357-1.

The thermally curable and radiation-curable formulations according to the invention have the advantage that they are obtained by a two-stage curing process, but without requiring a second crosslinking component as in conventional dual-cure systems.

An essential constituent of the formulations according to the invention is the radiation-curable resins of component A). These are systems known to those skilled in the art. The preparation of radiation-curable resins, oligomers and/or polymers is described, for example, in “Radiation Curing in Polymer Science & Technology, Vol I: Fundamentals and Methods” by J. P. Fouassier, J. F. Rabek, Elsevier Applied Science, London and New York, 1993, Chapter 5, pages 226 to 236; in “Lackharze” [Coating Resins], D. Stoye, W. Freitag, Hanser-Verlag, Vienna, 1996, pages 85, 94-98, 169 and 265 and in EP 947 565.

Suitable resins of component A) are, for example, epoxy acrylates, polyester acrylates, polyether acrylates, polyacrylate acrylates and urethane acrylates and/or polyester urethane acrylates, alone or in mixtures. In the case of the urethane acrylates, these are based, for example, on polyesters or else on polyethers. The corresponding methacrylates are known as well. Other compounds having polymerizable groups are epoxides and vinyl ethers. These too may be attached to various base resins.

Also useful for A) are liquid radiation-curable components, called reactive diluents.

Radiation-curable reactive diluents A) and the preparation thereof are described, for example, in “Radiation Curing in Polymer Science & Technology, Vol I: Fundamentals and Methods” by J. P. Fouassier and J. F. Rabek, Elsevier Applied Science, London and New York, 1993, Chapter 5, pages 237 to 240. These are generally acrylate- or methacrylate-containing materials which are liquid at room temperature and hence are capable of lowering the overall viscosity of the formulation. Examples of such reactive diluents are isobornyl acrylate (IBOA), hydroxypropyl methacrylate, trimethylolpropane monoformal acrylate, tetrahydrofurfuryl acrylate, phenoxyethyl acrylate, trimethylolpropane triacrylate, dipropylene glycol diacrylate, tripropylene glycol diacrylate, hexanediol diacrylate, pentaerythritol tetraacrylate, lauryl acrylate, and propoxylated or ethoxylated variants of these reactive diluents and/or urethanized reactive diluents such as EBECRYL 1039 (Cytec), and are used alone or in mixtures. Also useful are other liquid components capable of reacting with, for example, vinyl ether or ally! ether under free-radical polymerization conditions.

The amount A) in the formulation varies from 45% to 99.9% by weight, preferably 10% to 50% by weight, based on the overall formulation. Particular preference is given to polyester urethane acrylates. Examples thereof are VESTICOAT EP 110 IBOA (commercial product from Evonik Industries AG, Germany, Coatings & Colorants, difunctional polyester urethane acrylate) and EBECRYL 1256 (commercial product from Cytec, trifunctional polyester urethane acrylate). Particular preference is also given to monofunctional reactive diluents, especially isobornyl acrylate and/or trimethylolpropane monoformal acrylate.

Preference is given to using, as component A), mixtures of resins of component A) as described above and monofunctional reactive diluents.

Possible suitable photo-initiators (PI) (B) and their preparation are described, for example, in “Radiation Curing in Polymer Science & Technology, Vol II: Photoinitiating Systems” by J. P. Fouassier, J. F. Rabek, Elsevier Applied Science, London and New York, 1993. These are frequently α-hydroxy ketones or derivatives thereof The PIs may be present in amounts of 0.1% to 10% by weight, based on the overall formulation. A crucial factor for the suitability of the specific PIs is the property of still being thermally activatable at temperatures <160° C. after irradiation with UV rays. This can be tested by a preliminary test in which a reactive diluent, preferably IBOA, is provided with 2% by weight of PI. This mixture is partly free-radically polymerized to an extent of 20%-80% under a UV lamp and then subjected to a DSC analysis. If the maximum of the exothermic peak in degrees Celsius is at temperatures of <160° C., measured by means of DSC to DIN EN ISO 11357-1, this PI is suitable. If no exothermic peak is seen or it is above 160° C., the PI in question in unsuitable. Particularly suitable photo-initiators are those for which the exothermic peak is below 140° C.

Suitable photo-initiators are, for example, CHIVACURE 300 (oligo[2-hydroxy-2-methyl-1-[4-(1-methylvinyl)phenyl]propanone], CAS No.: 163702-01-0) and CHIVACURE 534 (bis(η5-2,4-cyclopentadien-1-yl)-bis(2,6-difluoro-3-(1H-pyrrol-1-yl)phenyl)titanium, CAS No.: 125051-32-3) (Chitec), IRGACURE 184 (CAS No.: 947-19-3, 1-hydroxycyclohexyl phenyl ketone), IRGACURE 651 (2,2-dimethoxy-1,2-diphenylethan-1-one, CAS No.: 24650-42-8) and IRGACURE 819 (BASF) (phenylbis(2,4,6-trimethylbenzoyl)phosphine oxide, CAS No.: 162881-26-7), DAROCURE 1173 (2-hydroxy-2-benzoylpropane, CAS No.: 7473-98-5) (BASF).

Useful additives C) especially include adhesion promoters, pigments, inhibitors, stabilizers, degassing agents, levelling agents, solvents.

Optionally, the formulations according to the invention may comprise adhesion promoters C). In general, adhesion promoters for radiation-curable formulations for metallic substrates consist of phosphoric acid and/or phosphonic acid and/or reaction products thereof (e.g. esters) with functionalized acrylates. While the free phosphoric acid groups are responsible for the direct adhesion to the metal, the acrylate groups ensure a bond to the coating matrix. Products of this kind are described, for example, in WO 01/98413, in JP 08231564, and in JP 06313127, the disclosure of which is hereby incorporated by reference.

Typical commercial products are EBECRYL 168, 169 and 170 from Cytec, ALDITOL Vxl 6219 from VIANOVA, CD 9050 and CD 9052 from Sartomer, SIPOMER PAM-100, SIPOMER PAM-200 and SIPOMER PAM-300 from Rhodia and GENORAD 40 from Rahn.

Suitable pigments for the radiation-curable formulations according to the present invention are described, for example, in “Radiation Curing in Polymer Science & Technology, Vol IV: Practical Aspects and Application” by J. P. Fouassier, J. F. Rabek, Elsevier Applied Science, London and New York, 1993, Chapter 5, pages 87 to 105, and may be present in amounts of 1% to 40% by weight. Examples of anticorrosion pigments can be found, for example, in Pigment+Füllstoff Tabellen [Pigment+Filler Tables], O. Lückert, Vincentz Verlag Hanover, 6th edition 2002. Examples include: SHIELDEX C 303 (Grace Davison) and HALOX Coil X 100, HALOX Coil X 200 and HALOX CW 491 (Erbslöh), HEUCOPHOS SAPP or else ZPA (Heubach), K-White TC 720 (Tayca) and HOMBICOR (Sachtleben). Other options are of course also simple inorganic salts, for example zinc phosphate, or else chromatic pigments. The amount of such pigments varies from 1% to 50% by weight, based on the overall formulation, if present.

Other additives C) for the radiation-curable formulations exist in various compositions and for various purposes.

Some of them are described in the brochure “SELECTED DEGUSSA PRODUCTS FOR RADIATION CURING AND PRINTING INKS”, published by Tego Coating & Ink Additives, Essen, 2003. The amount of such additives varies from 0.01% to 5% by weight, based on the overall formulation, if present.

Useful solvents C) include all organic and inorganic liquids that are inert under the reaction conditions. Examples include acetone, ethyl acetate, butyl acetate, xylene, Solvesso 100, Solvesso 150, methoxypropyl acetate and dibasic esters and water.

The amount of solvent is 1%-50% by weight, based on the overall formulation, if present.

The homogenization of all the constituents for producing the composition of the invention may take place in suitable assemblies, such as heatable stirred tanks, kneading devices or else extruders, for example, and upper temperature limits of 120 to 130° C. ought not to be exceeded.

The thoroughly mixed composition is applied to the substrate in an appropriate way (for example by rolling, spraying, squirting, dipping). After application, the coated workpieces, for curing in the presence of photo-initiators, are passed under a UV lamp (with or without protective gas). The radiation dose is such that the curing is not yet complete. For this purpose, an average of at least 20%, but not more than 95%, of the polymerizable double bonds are reacted. The degree of curing is measured either with an IR spectrometer or with a Fourier transform infrared spectrometer (FTIR spectroscopy), by measuring and determining the double bonds still present in component A). For this purpose, the basis used is the intensity of the bands at 1200 and 1280 cm-1. This method is known to those skilled in the art; see, for example, Hans-Ulrich Gremlich, Helmut Günzler: IR-Spektroskopie: Eine Einführung [IR Spectroscopy: An Introduction], 4th edition, Wiley-VCH, 2003; Griffiths, P.; de Hasseth, J.A. (18 May 2007), Fourier Transform Infrared Spectrometry (2nd ed.), Wiley-Blackwell, ISBN 0-471-19404-2.

A possible further operation, for example shaping, overcoating, laminating, involves heating to a temperature of 60 to 220° C. for 4 to 60 minutes, preferably at 80 to 160° C. for 6 to 30 minutes, for full thermal curing of the coating.

UV curing and suitable UV lamps are described, for example, in “Radiation Curing in Polymer Science & Technology, Vol I: Fundamentals and Methods” by J. P. Fouassier and J. F. Rabek, Elsevier Applied Science, London and New York, 1993, Chapter 8, pages 453 to 503.

The present invention further provides for the use of the thermally curable and radiation-curable formulations according to the invention as coating compositions, especially as a primer, intermediate layer, topcoat, clearcoat, adhesive or sealant material, and the coating compositions themselves.

The invention also provides for the use of the thermally curable and radiation-curable formulations according to the invention for production of liquid and pulverulent coatings on metal substrates, plastic substrates, glass substrates, wood substrates or other substrates, or other heat-resistant substrates.

The invention also provides for the use of the thermally curable and radiation-curable formulations according to the invention as adhesive compositions for bonds of metal substrates, plastic substrates, glass substrates, wood substrates, textile substrates or leather substrates, or other heat-resistant substrates.

Likewise provided by the invention are metal-coating compositions, more particularly for car bodies, motorcycles and pedal cycles, parts of buildings and household appliances, wood coating compositions, glass coating compositions, textile coating compositions, leather coating compositions and plastic coating compositions.

The coating can either be used alone, or may be one layer of a multilayer structure. They may be applied, for example, as a primer, as an intermediate layer or as a topcoat or clearcoat. The layers above or beneath the coating may either be cured thermally in a conventional manner, or else by means of radiation.

The present invention is explained in more detail below with reference to examples. Alternative embodiments of the present invention are obtainable analogously.

Having generally described this invention, a further understanding can be obtained by reference to certain specific examples which are provided herein for purposes of illustration only, and are not intended to be limiting unless otherwise specified.

### EXAMPLES

TABLE 1

| Feedstocks | Product description, manufacturer |
|---|---|
| DYNAPOL R 110 | Radiation-curable resin, urethane acrylate 75% |
| | by weight in 25% by weight isobornyl acrylate, |
| | Evonik Industries AG, Coatings & Additives |
| IRGACURE 184 | Photo-initiator, BASF |
| IRGACURE 651 | Photo-initiator, BASF |
| IRGACURE 651 | Photo-initiator, BASF |
| CHIVACURE | Photo-initiator, Chitec |
| CHIVACURE | Photo-initiator, Chitec |
| DAROCURE | Photo-initiator, BASF |
| H-Nu-470IL* | Photo-initiator, Spectra |
| IRGACURE 2959* | Photo-initiator, BASF |
| IRGACURE 127* | Photo-initiator, BASF |
| Isobornyl acrylate | Reactive diluent, Aldrich |
| Hexanediol diacrylate | Reactive diluent, Aldrich |

*non-inventive comparative examples

### A) Preliminary Tests

Isobornyl acrylate was mixed with 2% by weight of the photo-initiator and applied to a steel sheet (Q-Panel R36) with a bar applicator (100 μm).

This was followed by drying with a UV-LED lamp (Heraeus NobleCure@ based on water-cooled heat sink, wavelength: 395±5 nm, power density: 8 W/cm² at working distance 5 mm, emission window: 251×35 mm²) for 5 s.

This polymerized an average of about 30%-70% of the double bonds.

Thereafter, a sample of the coating was taken and analyzed by DSC (Mettler DSC I, 10 K/min). The maximum of the exothermic peak in degrees Celsius is reported in Table 2 below. The mixtures and coatings thus produced which have a maximum of the exothermic peak in degrees Celsius of less than or equal to 160° C. were suitable in accordance with the invention.

TABLE 2

| | Maximum exothermicity [° C.] |
|---|---|
| Experiment/component | by DSC: |
| IRGACURE 184 | 159 |
| IRGACURE 651 | 135 |
| IRGACURE 819 | 108 |
| CHIVACURE 300 | 154 |
| CHIVACURE 534 | 142 |
| DAROCURE 1173 | 151 |
| H-Nu-470IL* | 161 |
| IRGACURE 2959* | 172 |
| IRGACURE 127* | 163 |

*non-inventive comparative examples

### B) Coating Experiments

1) Inventive:

100 g of DYNAPOL R 110 and 125 g of isobornyl acrylate were mixed with 4.5 g of IRGACURE 819 and applied with a 50 μm coating bar to a steel sheet (Q-Panel R 36). Thereafter, a UV instrument (Minicure, mercury vapor lamp, 80 W/cm, 2×5 m/min) was used to cure about 80% of the double bonds (FTIR). The coating was tack-free and had Erichsen cupping (DIN 53156) of 9 mm. The T-bend (DIN EN 13523-7) is 3. After a further thermal curing operation (15 min at 150° C.), the T-bend rose to >4.
2) Inventive:

100 g of DYNAPOL R 110, 100 g of isobornyl acrylate and 25 g of hexanediol diacrylate were mixed with 4.5 g of IRGACURE 819 and applied with a 50 μm coating bar to a steel sheet (Q-Panel R 36). Thereafter, a UV instrument (Minicure, mercury vapor lamp, 80 W/cm, 2×5 m/min) was used to cure about 80% of the double bonds. The coating was tack-free and had Erichsen cupping of 9.5 mm. The T-bend is 2. After a further thermal curing operation (15 min at 150° C.), the T-bend rose to 4.
A) Non-inventive, comparison:
100 g of DYNAPOL R 110 and 125 g of isobornyl acrylate were mixed with 4.5 g of IRGACURE 2959 and applied with a 50 μm coating bar to a steel sheet (Q-Panel R 36).

Thereafter, a UV instrument (Minicure, mercury vapor lamp, 80 W/cm, 2×5 m/min) was used to cure about 75% of the double bonds. The coating was tack-free and has Erichsen cupping of 9 mm. The T-bend was 3. After a further thermal curing operation (15 min at 150° C.), the T-bend was unchanged at 3.

In the inventive case, the crosslinking density rose further after the thermal curing; the flexibility fell. In the non-inventive case, the crosslinking density did not rise any further.

The inventive formulations were superior to the non-inventive formulations in all coating data. In particular, the inventive formulation, after thermal curing, even without prior object curing, showed a minimum level of coating properties: freedom from tack, flexibility (Erichsen cupping >7 mm) and chemical resistance (MEK test >20 double strokes).

### Test Methods

Erichsen cupping to DIN 53156, ball impact to ASTM D 2794-93

T-bend test method (flexural test) to DIN EN 13523-7

### DSC Measurements

The DSC measurements were conducted to DIN EN ISO 11357—Mar. 1, 2010.

A heat flux differential calorimeter from the manufacturer Mettler-Toledo, model: DSC 821 with serial number: 5116131417 was used. The samples were run once from −30° C. to 250° C. at 10 K/min.

### Detailed Description of the Test Method:

1. Type (heat flux differential calorimeter or performance-compensated calorimeter), model and manufacturer of the DSC unit used;
2. Material, form and type and, if required, mass of the crucible used;

3. Type, purity and flow rate of the purge gas used;
4. Type of calibration method and details of the calibration substances used, including source, mass and further properties of significance for the calibration;
5. Details of sampling, sample preparation and conditioning
1: Heat flux differential calorimeter
   Manufacturer: Mettler-Toledo
   Model: DSC 821
   Ser. No.: 5116131417
2: Crucible material: ultrapure aluminium
   Size: 40 μl, no pin,
   Mettler cat. no.: ME-26763
   Mass including lid: about 48 mg
3: Purge gas: nitrogen
   Purity: 5.0 (>99.999% by vol.)
   Flow rate: 40 ml/min
4: Calibration method: simple
   Material 1: indium
   Mettler calibration set ME-51119991
   Mass: about 6 mg per weighing
   Calibration of temperature (onset) and heat flow
   Material 2: demineralized water
   Taken from the in-house system
   Mass: about 1 mg per weighing
   Calibration of temperature (onset)
5: Sampling: from sample bottles supplied
   Sample weight: 8 to 10 mg
   Sample preparation: pressed onto crucible base with a punch
   Crucible lid: perforated
   Measurement program: −30 to 250° C., 10 K/min, 1×

European patent application EP14199251 filed Dec. 19, 2014, is incorporated herein by reference.

Numerous modifications and variations on the present invention are possible in light of the above teachings. It is therefore to be understood that within the scope of the appended claims, the invention may be practiced otherwise than as specifically described herein.

1. A process for producing a coating, comprising:
applying a thermally curable and radiation-curable formulation to a substrate, to obtain a coated substrate;
curing said thermally curable and radiation-curable formulation at least partly but not fully with radiation, to obtain a partly cured coated substrate; wherein an average of at least 20% to not more than 95% of polymerizable double bonds of the thermally curable and radiation-curable formulation are reacted during the curing;
wherein the thermally curable and radiation-curable formulation comprises
A) 45% to 99.9% by weight of at least one radiation-curable component; and
B) 0.1% to 5% by weight of at least one selected free-radically initiating photo-initiator;
and optionally
C) 0.01% to 50% by weight of at least one additive;
wherein the sum total of A) and B) and any C) is 100% by weight;
and then thermally heating the coating on the substrate at a temperature from 60 to 220° C., to fully cure the coating, to obtain a cured coating.

2. The process according to claim 1, wherein
the photo-initiator B) is selected according to the following method in a preliminary test:
2% by weight of the photo-initiator is dissolved in isobornyl acrylate and coated with a layer thickness of 100 gm on a substrate and 20-80% of the double bonds of the isobornyl acrylate are free-radically polymerized by a UV lamp, to obtain a coating having a maximum in the exothermic peak in degrees Celsius at temperatures less than or equal to 160° C., as measured by DSC according to DIN EN ISO 11357-1.

3. The process according to claim 2, wherein the exothermic peak is below 140° C.

4. The process according to claim 1, wherein said component A) is selected from the group consisting of epoxy acrylates, polyester acrylates, polyether acrylates, polyacrylate acrylates, urethane acrylates, polyester urethane acrylates, and mixtures thereof.

5. The process according to claim 1, wherein said component A) is selected from the group consisting of polyester urethane acrylates.

6. The process according to claim 1, wherein said component A) is selected from the group consisting of reactive diluents.

7. The process according to claim 1, wherein said component A) is selected from the group consisting of isobornyl acrylate, hydroxypropyl methacrylate, trimethylolpropane monoformal acrylate, tetrahydrofurfuryl acrylate, phenoxyethyl acrylate, trimethylolpropane triacrylate, dipropylene glycol diacrylate, tripropylene glycol diacrylate, hexanediol diacrylate, pentaerythritol tetraacrylate, lauryl acrylate, propoxylated or ethoxylated variants of these reactive diluents and/or urethanized reactive diluents, vinyl ethers, allyl ethers, and mixtures thereof.

8. The process according to claim 1, wherein said component A) is selected from the group consisting of isobornyl acrylate, trimethylolpropane monoformal acrylate and mixtures thereof.

9. The process according to claim 1, wherein said component A) comprises mixtures of resins of component A) and monofunctional reactive diluents.

10. The process according to claim 1, wherein said component B) is selected from the group consisting of oligo[2-hydroxy-2-methyl-1-[4-(1-methylvinyl)phenyl]propanone], bis(η5-2,4-cyclopentadien-1-yl)-bis(2,6-difluoro-3-(1H-pyrrol-1-yl)phenyl)titanium, 1-hydroxycyclohexyl phenyl ketone, 2,2-dimethoxy-1,2-diphenylethan-1-one, phenylbis(2,4,6-trimethylbenzoyl)phosphine oxide, 2-hydroxy-2-benzoylpropane, and mixtures thereof.

11. The process according to claim 1, wherein said component C) is selected from the group consisting of adhesion promoters, pigments, inhibitors, stabilizers, degassing agents, levelling agents, solvents and mixtures thereof.

12. The process according to claim 1, wherein the coating is heated to a temperature of 60 to 220° C. for 4 to 60 minutes, and is fully thermally cured.

13. The process according to claim 1, wherein the coating is heated to a temperature of 80 to 160° C. for 6 to 30 minutes, and is fully thermally cured.

14. A thermally curable and radiation-curable formulation, comprising:
A) 45% to 99.9% by weight of at least one radiation-curable component; and
B) 0.1% to 5% by weight of at least one selected free-radically initiating photo-initiator;
and optionally
C) 0.01% to 50% by weight of at least one additive;
wherein the sum total of A) and B) and any C) is 100% by weight.

15. The thermally curable and radiation-curable formulation according to claim 14, wherein the photo-initiator B) is selected according to the following test:
2% by weight of the photo-initiator is dissolved in isobornyl acrylate and coated with a layer thickness of 100 μm on a substrate and 20-80% of the double bonds of the isobornyl acrylate are free-radically polymerized by a UV lamp, to obtain a coating having a maximum in the exothermic peak in degrees Celsius at temperatures less than or equal to 160° C., as measured by DSC according to DIN EN ISO 11357-1.

16. The thermally curable and radiation-curable formulation according to claim 14, wherein said component A) is selected from the group consisting of epoxy acrylates, polyester acrylates, polyether acrylates, polyacrylate acrylates, urethane acrylates, polyester urethane acrylates, and mixtures thereof.

17. The thermally curable and radiation-curable formulation according to claim 14, wherein said component A) is selected from the group consisting of reactive diluents.

18. The thermally curable and radiation-curable formulation according to claim 14,
wherein said component B) is selected from the group consisting of oligo[2-hydroxy-2-methyl-1-[4-(1-methylvinyl)phenyl]propanone], bis(η5-2,4-cyclopentadien-1-yl)-bis(2,6-difluoro-3-(1H-pyrrol-1-yl)phenyl)titanium, 1 -hydroxycyclohexyl phenyl ketone, 2,2-dimethoxy-1,2-diphenylethan-1-one, phenylbis(2,4,6-trimethylbenzoyl)phosphine oxide, 2-hydroxy-2-benzoylpropane, and mixtures thereof.

19. A coating material, intermediate layer, topcoat, clearcoat, adhesive or sealant material, comprising:
the thermally curable and radiation-curable formulation according to claim 14.
